(19) United States
(12) Patent Application Publication
(10) Pub. No.: US 2020/0311673 A1
(43) Pub. Date: Oct. 1, 2020

(54) IN-FLIGHT DELIVERY

(71) Applicant: Honda Motor Co., Ltd., Tokyo (JP)

(72) Inventors: Michael T. SAILER, Whittier, CA (US); Annika E. Nordlund-Swenson, Seattle, WA (US); Nathan G. Brown, Long Beach, CA (US); Jamie O'Brien, Singapore (SG)

(21) Appl. No.: 16/368,932

(22) Filed: Mar. 29, 2019

(51) Int. Cl. G06Q 10/08; G06Q 10/04; G06Q 30/06; B64C 39/02; B64B 1/06

(52) U.S. Cl. CPC G06Q 10/08355; G06Q 10/047; G06Q 30/0635; B64C 2201/128; B64C 39/024; B64B 1/06; G06Q 30/0621

(57) ABSTRACT

The systems and methods provided herein are directed to a delivery system for orders from a variety of businesses located along a transport route of an aerial vehicle. Fresh food, geographically unique goods, customized goods, and other retail items are ordered by passengers while in transit over ground-based locations. Scheduled in-flight deliveries provide the ordered goods to the passengers.

### BACKGROUND AND BRIEF DESCRIPTION

Lighter-than-air transport can provide an energy efficient and comfortable form of passenger transportation compared to airplane travel, but is significantly slower. One potential trade-off for the longer transit time is a larger and more open floor plan for passengers, in some respects more like the deck of a ship than the confines of a plane cabin.

The quality of dining services is often a significant consideration for transportation that can require half a day or more. A leisurely traverse across a number of ground-based locations creates a unique opportunity for a breadth of customer options.

The present disclosure describes systems and methods for in-flight delivery. At certain intervals during an air trip, a passenger is given the option to order goods originating at different ground-based locations and delivered to the passenger in transit. One example of such good would be food items freshly prepared at different locations in response to a customer's order.

According to one embodiment, a computer-implemented method includes determining a ground-based location list based on a travel route of an aerial vehicle; placing an order to a ground-based location on the list, the order including a time window corresponding to the proximity of the aerial vehicle to the ground-based location; and arranging, within the included time window, a delivery associated with the placed order by an unmanned aerial vehicle from the ground-based location to the aerial vehicle while the aerial vehicle is on the travel route.

In one embodiment, the delivery includes food freshly prepared at the ground-based location in response to the order.

In one embodiment, the method also includes presenting, while the aerial vehicle is on the travel route, the list of ground-based locations to a passenger on board the aerial vehicle; and receiving, from the passenger, a selection corresponding to the order.

In one embodiment, the ground-based location list further includes a time window associated with each of the ground-based locations on the list. The time window for the order to the ground-based location is based on that location's associated time window on the ground-based location list.

In one embodiment, the method also includes placing a second order to a second ground-based location on the list; and arranging a second delivery by an unmanned aerial vehicle from the second ground-based location to the aerial vehicle while the aerial vehicle is on the travel route. In some aspects of the embodiment, the second delivery is by the same unmanned aerial vehicle as the first delivery. In some aspects, the second delivery is by a different unmanned aerial vehicle from the first delivery.

In one embodiment, wherein the delivery includes goods uniquely associated with the ground-based location.

In one embodiment, the order further includes instructions for customization of handmade goods. The delivery includes goods made according to the instructions in the order.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIGS. 1A-C show screenshots of an interactive map provided as part of an in-flight ordering application in accordance with one aspect of the present disclosure;

FIG. 2A shows a menu provided as part of the application in accordance with one aspect of the present disclosure;

FIG. 2B show an order entry and its inclusion on a drone manifest in accordance with one aspect of the present disclosure;

FIG. 3 is a flow diagram illustrating an exemplary method for providing in-flight ordering information to a passenger in accordance with one aspect of the present disclosure; and

FIG. 4 is a flow diagram illustrating an exemplary method for providing in-flight delivery to a passenger in accordance with one aspect of the present disclosure.

### DESCRIPTION OF THE DISCLOSURE

The description set forth below in connection with the appended drawings is intended as a description of exemplary embodiments of the disclosure and is not intended to represent the only forms in which the present disclosure can be constructed and/or utilized. The description sets forth the functions and the sequence of blocks for constructing and operating the disclosure in connection with the illustrated embodiments. It is to be understood, however, that the same or equivalent functions and sequences can be accomplished by different embodiments that are also intended to be encompassed within the spirit and scope of this disclosure.

Generally described, the systems and methods herein are directed to a dynamic ordering and delivery process for passengers traveling an established route. Although examples are given in terms of slow-moving aerial travel, one of ordinary skill in the art will recognize that many of the techniques described therein may be applicable to other travel scenarios, some examples of which will be given in this disclosure.

Furthermore, while many of the examples are given in terms of ordering fresh food from a menu, it will be understood that any retail good could be ordered from ground-based locations and described herein. As a particular example, customized handmade goods may be specified by a passenger and delivered during transit just as described below for the ordering and preparation of food. Regular, off-the-shelf goods may also be on offer; the passenger benefits from the variety of goods available from many different ground-based locations, plus the convenience of the items being delivered while the passenger is in transit.

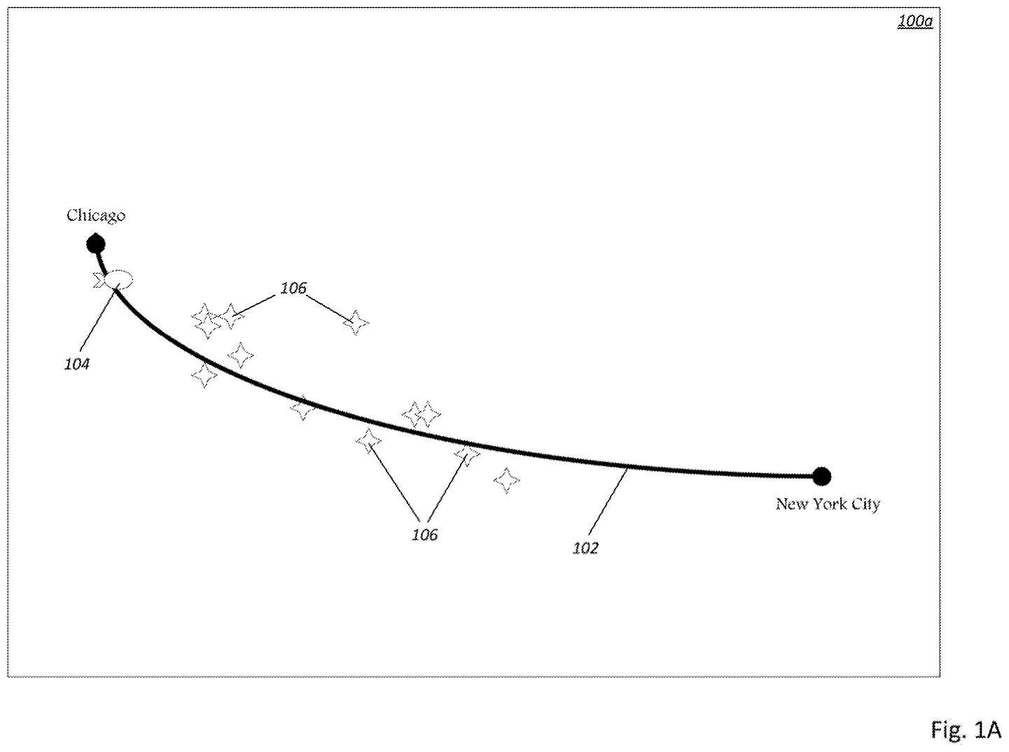

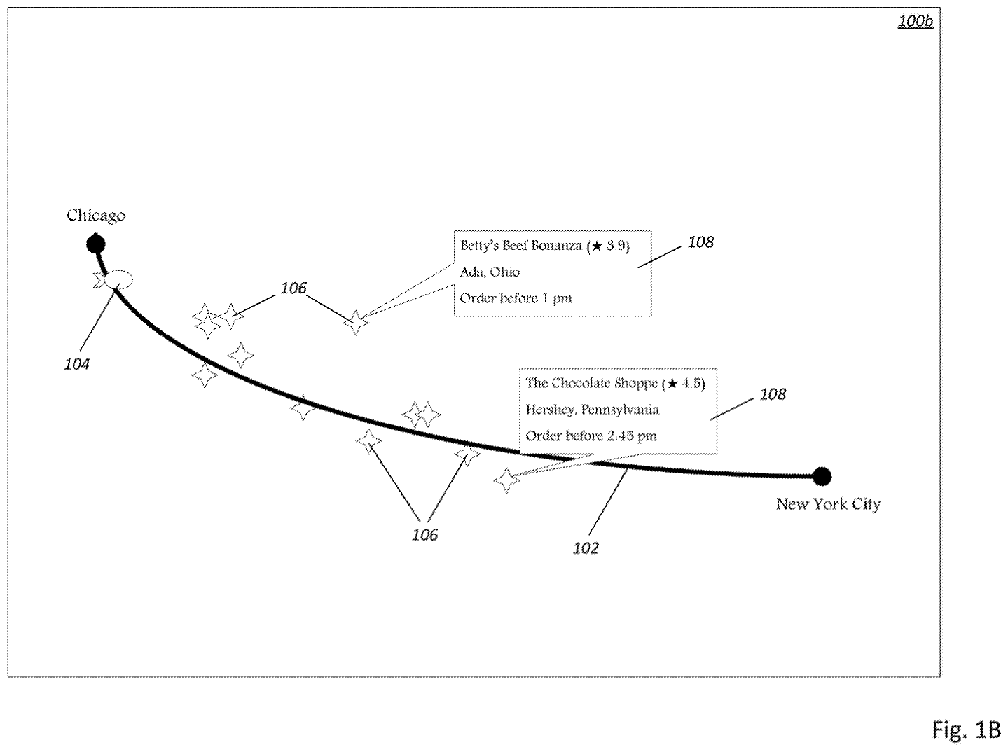

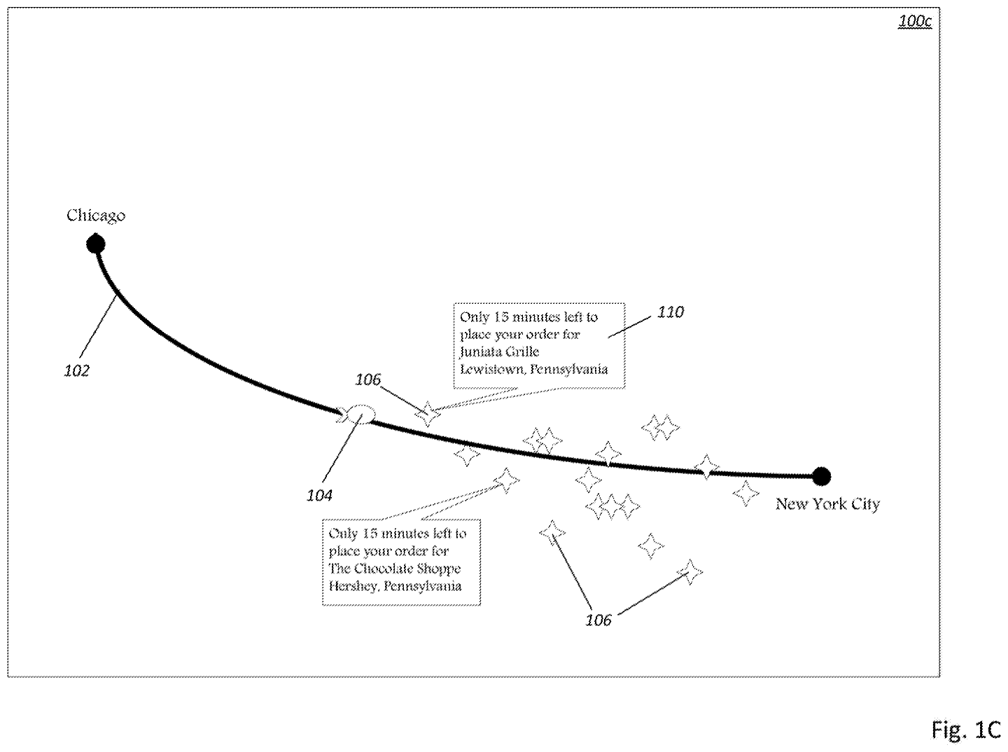

FIG. 1A depicts a screen display 100a of an airship route 102 taken by a passenger. As shown, the airship 104 will move between Chicago and New York over a period of 8 hours. Along the route 102, several retail locations participating in the drone delivery program are displayed. Map markers 106 give the locations of each of the retail locations.

As FIG. 1B shows on a screen display 100b, upon the user selecting a particular marker 106, an information box 108 is displayed providing details about the particular location. Summary information, a location, and user ratings may be given on the information box 108. Additionally, a time window is provided for the user to make an order to the selected location.

FIG. 1C depicts the screen display 100c at a later time, as shown by the position of the airship 104 along the route 102. Notably, many of the map markers 106 visible previously are no longer displayed, because the airship has progressed far enough that their window for ordering is expired. Additional markers 106 reflecting later time windows for ordering are now displayed, along with those previously displayed map markers for locations still open to ordering. Alerts 110 are associated with two of the locations indicating that the user only has a few more minutes to order from these locations.

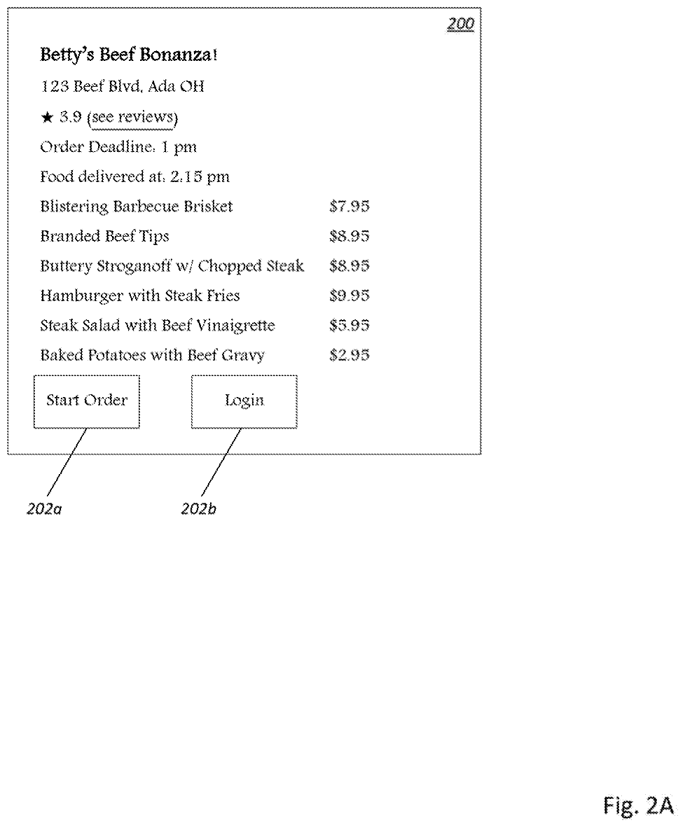

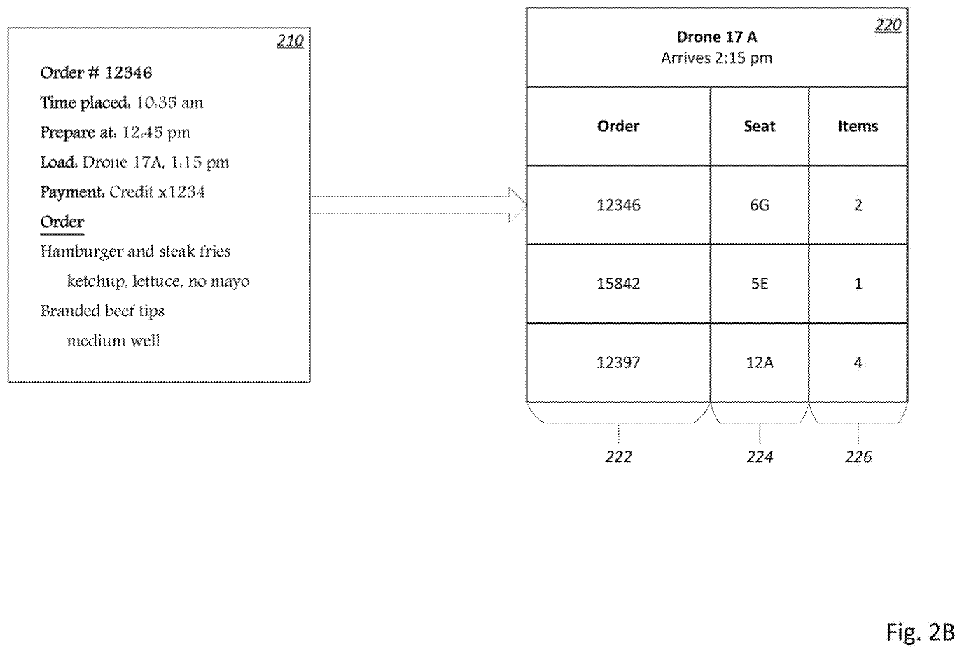

FIG. 2A shows a menu 200 that is displayed to a user upon selecting the information box 108 from the display 100b. The menu 200 includes information about the selected business, including a link to reviews by other users, information about order deadlines and delivery times, available food items with prices. A user can then select a button 202a to order, or a different button 202b to first login and provide information associated with their user account. Other informational and service options may be provided on the menu display.

As shown in FIG. 2B, a system may respond to a user's order by providing an order message 210 to the relevant business. The message 210 may include order information, such as when the order was placed, when and where the ordered items should be loaded for delivery, and an estimate of when to begin preparing the order to assure it is as fresh as possible when delivered.

The order may also be added to a drone manifest 220, which provides information to someone managing the delivery of the retail items for the passengers who ordered it (such as an employee of the airship). The manifest 220 may include, for each different set of items that are scheduled to be delivered by that drone, an order number (column 222), a seat number for the passenger receiving the items (column 224), and a total number of items to be delivered as part of that order (column 226). In some implementations, all of the orders may be associated with the same business (such as a restaurant serving multiple customers). In some implementations, orders from different businesses may load onto the same drones. Drones could be navigated between ground-based locations for loading, or businesses may perform ground-based delivery of the items to a central location containing the drone to be loaded and launched.

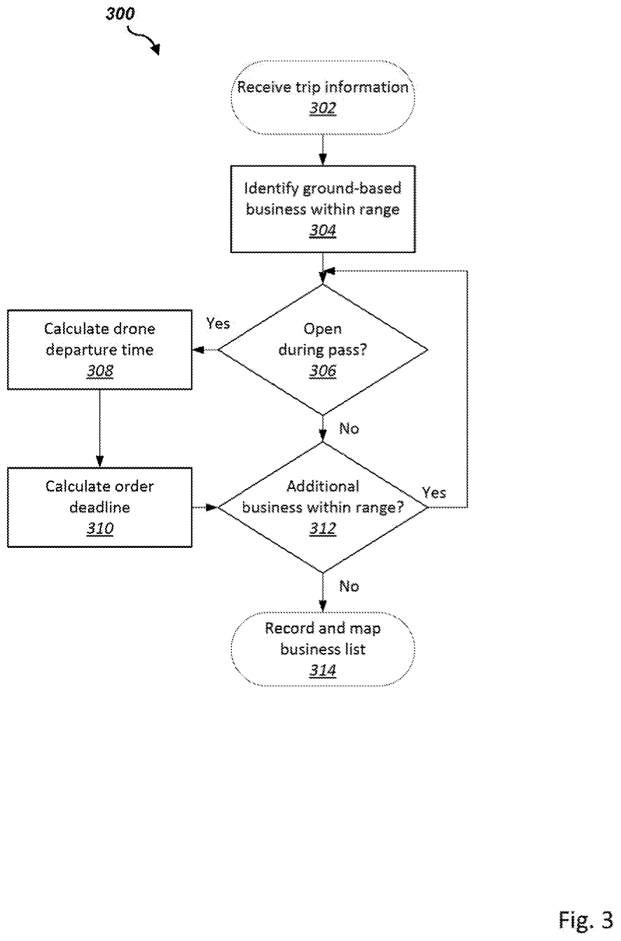

FIG. 3 is a flowchart describing a process 300 for associating a route with businesses. Although described in terms of an airship, it will be recognized that any transportation wherein it is logistically feasible to deliver goods from ground-based locations to passengers along the route could use this process 300.

A system receives trip information (step 302), which may be, for example, a route giving estimated times in which the transport will be at successive locations. Note that, in at least some implementations such as air travel, it may not be sufficient to receive end points and times, as the particular aerial route taken by the transport may affect the calculations made for timing and delivery of retail goods.

Based on the received information, the system checks for a participating business that are within range of the transport route (step 304). In some implementations, the constraining range factor may be based on the abilities of the drones. For example, a drone that can take a retail item payload no more than 15 miles will not be able to deliver goods from a location more than 15 miles away from the route. However, more flexible distance limitations may be possible for businesses willing to engage in, for example, supplemental transportation (which may itself be aerial, ground-based, or the like) to move ordered items from their location to a more favorable drone launch location.

The system checks the times that the participating business is open against the window of time in which the transport will pass close enough for delivery (step 308). As with the distance constraints, time windows may be made more flexible by supplemental accommodations made by the business. For example, a business closing before a transport approaches could prepare and load retail goods in the drone at an earlier time, while the business is still open. The goods would then still be delivered at the appropriate time, when the drone arrives at the transport. Various technologies for appropriate packaging of different goods (such as, for example, food temperature regulation and storage) are known in the art.

If the business matches both time and distance constraints for the route, then the system will determine when the drone would need to depart in order to deliver along the route (310). In some implementations, this calculation will be based on known values for drone speed and relative location. For example, a drone travelling at 15 mph from a launch point 5 miles from its intersection point with the route, will need to launch approximately 20 minutes before the transport arrives at the intersection point.

The calculated values for drone departure time may be at least partially based on estimated distances and locations, but may further be based on historical data for deliveries similar to the one being made. For instance, if recorded drone deliveries shows that drones travelling a given route (for example, traveling west in central Pennsylvania) consistently take more time than estimated based naively on distance would indicate, additional time can be allowed for in the future when drones are following those same routes.

Having determined when the drone will need to launch, the system then determines an order deadline for the business (step 312). In some implementations, the order deadline may be simply determined by adding estimated preparation time for an order to the calculated departure time. Preparation time may be set by a business, may have a default estimated value given by the system, or may be derived from factors including user reports and historical business activity. In some implementations, a business may be given the option to adjust the deadline to a time earlier than that calculated by the system, thus providing the business with control over giving additional leeway for preparation and loading of the goods.

The steps described above may be repeated for each additional business within range of the route (step 312), and when all such business are considered, a list of them may be recorded and mapped to be displayed to passengers for ordering as described above (314). One of ordinary skill in the art will recognize that while the above steps are generally described as being carried out algorithmically and automatically by systems, in practice some of the steps may be carried out at least partially by users of the system. In at least some implementations, the flexibility to override automated values and fields may be considered valuable.

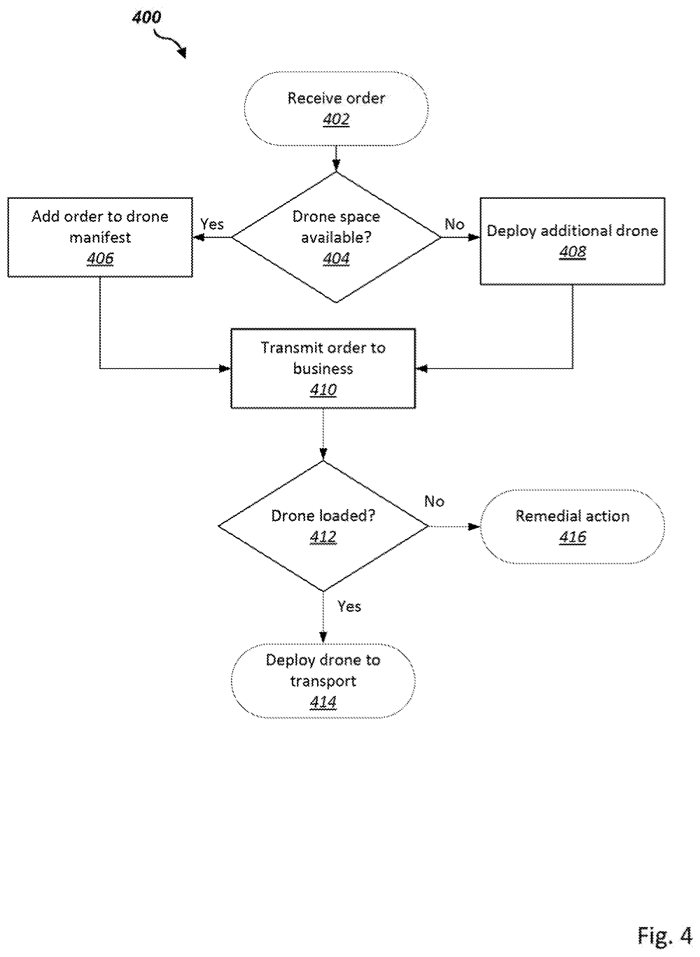

FIG. 4 is a flowchart illustrating a process 400 for reporting and automatically delivering via drone an order received by a passenger on a transport.

An order is received (402), which in some implementations may be by use of a map and menu system such as that described above with respect to FIGS. 1A-C. In some implementations, additional orders may be received from mechanisms other than the passenger menu. For example, orders associated with transport staff may be submitted by another means. Users may also be able to call or otherwise communicate with a ground-based business directly rather than using the menu system as an intermediary.

For each order received, however it is received, it is evaluated to see if there is space in any of the scheduled drones to include it (step 404). Both weight and volume considerations are evaluated against the existing scheduled drones, and the other orders each of those drones are taking.

If space is available, then the order may be added to the manifest for the drone delivering it (step 406). In some implementations an order may be split between multiple drones to accommodate it. For example, consider a scenario in which three passengers each ordered two items weighing five pounds each (for a total of six items weighing thirty pounds collectively). There are two drones available each able to deliver a payload of fifteen pounds. While there is no way to keep each order to one drone and still deliver all three orders, if one order is split so that each of the two drones can carry three of the items, then the two drones can deliver all three orders collectively.

Should the scheduled drones not accommodate the new order, in some implementations one or more additional drones may be deployed (408). There may be limitations as to the conditions under which adding additional delivery drones may be permitted. For example, a passenger ordering a low-value item may have their order only conditionally approved, pending additional orders to justify the deployment of additional drones.

More generally, the capacity and timing constraint of drones may in some implementations significantly impact the availability of orders under a number of conditions. For example, orders may be limited, and menu items or whole businesses may cease to be available for passengers to order from when delivery space has reached capacity. In contrast, where drone space is under-utilized, additional advertisements or even discounts may be presented to customers to incentivize more orders. The delivery system may be required to adapt in order to accommodate the constraints of both the route and the available delivery vehicles.

Once the system determines that there is drone availability for the order, then the order is provided to the business (step 410), which may happen with an order message as described in FIG. 2A. The user making the order may also be provided with a confirmation, either when the order is provided to the business, when the business accepts and verifies the order, or both.

At a later time, the system may determine, by verifications given by businesses and/or by sensors associated with the drone, that the drone has been loaded and is secured for launch and flight (step 412). When all orders are received and verified, the drone is deployed and navigates to connect with the transport (step 414).

In some cases, remedial action may need to be taken when all orders are not timely loaded into the drone (step 416). This remedial action may, for example, involve launching a partially filled drone for delivery, and then deploying a supplemental drone (possibly, for example, a faster drone with a smaller payload kept aside for such events) to deliver the missing order or orders. In other implementations, the remedial action may include a refund to a passenger, or an offer to a passenger to receive a later delivery of goods from a business farther along the route. Some remedial action may be automated, while other action may be administered by customer service professionals or others associated with the delivery system.

The data structures and code, in which the present disclosure can be implemented, can typically be stored on a non-transitory computer-readable storage medium. The storage can be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the disclosure can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described can be included in hardware components. For example, the hardware components can include, but are not limited to, application-specific integrated circuit (ASIC) chips, field-programmable gate arrays (FPGAs), and other programmable-logic devices now known or later developed. When the hardware components are activated, the hardware components perform the methods and processes included within the hardware components.

The technology described herein can be implemented as logical operations and/or components. The logical operations can be implemented as a sequence of processor-implemented executed blocks and as interconnected machine or circuit components. Likewise, the descriptions of various components can be provided in terms of operations executed or effected by the components. The resulting implementation is a matter of choice, dependent on the performance requirements of the underlying system implementing the described technology. Accordingly, the logical operations making up the embodiment of the technology described herein are referred to variously as operations, blocks, objects, or components. It should be understood that logical operations can be performed in any order, unless explicitly claimed otherwise or a specific order is inherently necessitated by the claim language.

Various embodiments of the present disclosure can be programmed using an object-oriented programming language, such as SmallTalk, Java, C++, Ada or C#. Other object-oriented programming languages can also be used. Alternatively, functional, scripting, and/or logical programming languages can be used. Various aspects of this disclosure can be implemented in a non-programmed environment, for example, documents created in HTML, XML, or other format that, when viewed in a window of a browser program, render aspects of a GUI or perform other functions. Various aspects of the disclosure can be implemented as programmed or non-programmed elements, or any combination thereof.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A computer-implemented method comprising:
determining a ground-based location list based on a travel route of an aerial vehicle;
placing an order to a ground-based location on the list, the order including a time window corresponding to the proximity of the aerial vehicle to the ground-based location; and
arranging, within the included time window, a delivery associated with the placed order by an unmanned aerial vehicle from the ground-based location to the aerial vehicle while the aerial vehicle is on the travel route.

2. The method of claim 1, wherein the delivery includes food freshly prepared at the ground-based location in response to the order.

3. The method of claim 1, further comprising:
presenting, while the aerial vehicle is on the travel route, the list of ground-based locations to a passenger on board the aerial vehicle; and
receiving, from the passenger, a selection corresponding to the order.

4. The method of claim 1, wherein the ground-based location list further includes a time window associated with each of the ground-based locations on the list, and wherein the time window for the order to the ground-based location is based on that location's associated time window on the ground-based location list.

5. The method of claim 1, further comprising:
placing a second order to a second ground-based location on the list; and
arranging a second delivery by an unmanned aerial vehicle from the second ground-based location to the aerial vehicle while the aerial vehicle is on the travel route.

6. The method of claim 5, wherein the second delivery is by the same unmanned aerial vehicle as the first delivery.

7. The method of claim 5, wherein the second delivery is by a different unmanned aerial vehicle from the first delivery.

8. The method of claim 1, wherein the delivery includes goods uniquely associated with the ground-based location.

9. The method of claim 1,
wherein the order further includes instructions for customization of handmade goods; and
wherein the delivery includes goods made according to the instructions in the order.
